(19) United States
(12) Patent Application Publication
(10) Pub. No.: US 2019/0191321 A1
(43) Pub. Date: Jun. 20, 2019

(54) INFORMATION PROCESSING APPARATUS, INFORMATION PROCESSING SYSTEM, INFORMATION PROCESSING METHOD, COMMUNICATION APPARATUS, AND COMMUNICATION SYSTEM

(71) Applicant: NEC Corporation, Tokyo (JP)

(72) Inventor: Takashi MIMURA, Tokyo (JP)

(73) Assignee: NEC Corporation, Tokyo (JP)

(21) Appl. No.: 16/213,365

(22) Filed: Dec. 7, 2018

(30) Foreign Application Priority Data
Dec. 19, 2017 (JP) 2017-242924

(51) Int. Cl. H04W 24/04; H04W 8/30

(52) U.S. Cl. CPC H04W 24/04; H04W 8/30

(57) ABSTRACT

An information processing apparatus (IPA) includes a mechanical storage apparatus that stores a program for the IPA to operate, and to store first information into the storage apparatus with updating of the first information for IPA to operate; a memory device of a writable type; and a controller configured to, during normal operation of the storage apparatus, transmit second information including at least a portion of the first information to a data center connected to the IPA a communication link, the controller being further configured to, upon detection of a failure of the storage apparatus, bring operation of the storage apparatus to a halt, load the second information and the program that is preliminarily stored in the data center, into the memory device from the data center, and allow the IPA to operate, based on the program and the second information, which have been loaded into the memory device.

This application is based upon and claims the benefit of priority from Japanese Patent Application No. 2017-242924, filed on Dec. 19, 2017, the disclosure of which is incorporated herein in its entirety by reference.

### TECHNICAL FIELD

The present invention relates to an information processing apparatus, an information processing system, an information processing method, a communication apparatus, and a communication system.

### BACKGROUND ART

When a failure has occurred in a storage apparatus, such as a data disk or the like, mounted in a communication apparatus of a wireless base station or the like at the time of the activation of the communication apparatus, an operator has sometimes had to go to a local site to replace the storage apparatus.

In Patent Document 1, there is presented a remote maintenance apparatus that, upon occurrence of a failure in a storage apparatus of a maintenance target computer, reactivates the maintenance target computer by a remote operation, using a recovery program and recovery information that are stored in another storage apparatus.

### PATENT DOCUMENT

[Patent Document 1] Japanese Unexamined Patent Application Publication No. Hei 10-011318

In the above-described remote maintenance apparatus presented in Patent Document 1, the plurality of storage apparatuses are needed.

In the case where the technique presented in Patent Document 1 is applied to a wireless base station, and this wireless base station is subjected to a strong impact due to a disaster or the like, there is a risk that the plurality of storage apparatuses, such as data disks or the like, may be simultaneously damaged and thereby the function of the wireless base station may be brought to a halt.

### SUMMARY

In view of the above-described disadvantage, an object of the present invention is to provide an information processing apparatus, an information processing system, an information processing method, a communication apparatus, and a communication system that, even when a failure has occurred in a storage apparatus, enable at least a portion of original operation to be automatically resumed.

In order to achieve the above-described object, an information processing apparatus according to a first aspect of the present invention includes a storage apparatus that is of a mechanical type and is configured to store, in the storage apparatus, a program for allowing the information processing apparatus to operate, and to store first information into the storage apparatus in conjunction with updating of the first information, the first information being information for allowing the information processing apparatus to operate; a memory device of a writable type; and a controller configured to, during normal operation of the storage apparatus, transmit second information including at least a portion of the first information to a data center connected to the information processing apparatus via a communication link, the controller being further configured to, upon detection of a failure of the storage apparatus, bring operation of the storage apparatus to a halt, load the second information and the program that is preliminarily stored in the data center, into the memory device from the data center, and allow the information processing apparatus to operate, based on the program and the second information, which have been loaded into the memory device.

In order to achieve the above-described object, an information processing system according to a second aspect of the present invention includes an information processing apparatus and a data center connected to the information processing apparatus via a communication link, the information processing apparatus including a storage apparatus that is of a mechanical type and is configured to store, in the apparatus, a program for allowing the information processing apparatus to operate, and to store first information into the storage apparatus in conjunction with updating of the first information, the first information being information for allowing the information processing apparatus to operate; a memory device of a writable type; and a controller configured to, during normal operation of the storage apparatus, transmit second information including at least a portion of the first information to the data center, which is connected to the information processing apparatus via the communication link, the controller being further configured to, upon detection of a failure of the storage apparatus, bring operation of the storage apparatus to a halt, load the second information and the program that is preliminarily stored in the data center, into the memory device from the data center, and allow the information processing apparatus to operate, based on the program and the second information, which have been loaded into the memory device.

In order to achieve the above-described object, an information processing method according to a third aspect of the present invention includes storing, in a storage apparatus of a mechanical type, a program for allowing an information processing apparatus to operate, and storing first information into the storage apparatus in conjunction with updating of the first information, the first information being information for allowing the information processing apparatus to operate. During normal operation of the storage apparatus, second information including at least a portion of the first information is transmitted to a data center connected to the information processing apparatus via a communication link. Upon detection of a failure of the storage apparatus, operation of the storage apparatus is brought to a halt, the second information and the program that is preliminarily stored in the data center are loaded into the memory device from the data center, and the information processing apparatus is allowed to operate, based on the program and the second information, which have been loaded into the memory device.

In order to achieve the above-described object, a communication apparatus according to a fourth aspect of the present invention includes a communication section configured to communicate through a first communication link; a storage apparatus that is of a mechanical type and is configured to store, in the storage apparatus, a program for allowing the communication apparatus to operate, and to store first information into the storage apparatus in conjunction with updating of the first information, the first information being information for allowing the communication apparatus to operate; a memory device of a writable type; and a controller configured to, during normal operation of the storage apparatus, transmit second information including at least a portion of the first information to a data center connected to the communication apparatus via a second communication link, the controller being further configured to, upon detection of a failure of the storage apparatus, bring operation of the storage apparatus to a halt, load the second information and the program that is preliminarily stored in the data center, into the memory device from the data center, and allow the communication apparatus to operate, based on the program and the second information, which have been loaded into the memory device.

In order to achieve the above-described object, a communication system according to a fifth aspect of the present invention includes a communication apparatus and a data center connected to the communication apparatus via a second communication link, the communication apparatus including a communication section configured to communicate through a first communication link; a storage apparatus that is of a mechanical type and is configured to store, in the storage apparatus, a program for allowing the communication apparatus to operate, and to store first information into the storage apparatus in conjunction with updating of the first information, the first information being information for allowing the communication apparatus to operate; a memory device of a writable type; and a controller configured to, during normal operation of the storage apparatus, transmit second information including at least a portion of the first information to the data center, the controller being further configured to, upon detection of a failure of the storage apparatus, bring operation of the storage apparatus to a halt, load the second information and the program that is preliminarily stored in the data center, into the memory device from the data center, and allow the communication apparatus to operate, based on the program and the second information, which have been loaded into the memory device.

According to some aspects of the present invention, an information processing apparatus, an information processing system, an information processing method, a communication apparatus, and a communication system that, even when a failure has occurred in a storage apparatus, enable at least a portion of original operation to be automatically resumed are achieved.

### BRIEF DESCRIPTION OF THE DRAWINGS

Exemplary features and advantages of the present invention will become apparent from the following detailed description when taken with the accompanying drawings in which:

FIG. 1 is a diagram illustrating a configuration example of a first example embodiment.

FIG. 2 is a diagram illustrating a configuration example of a second example embodiment.

FIG. 3 is a diagram illustrating the operation of the second example embodiment.

### EXAMPLE EMBODIMENT

### First Example Embodiment

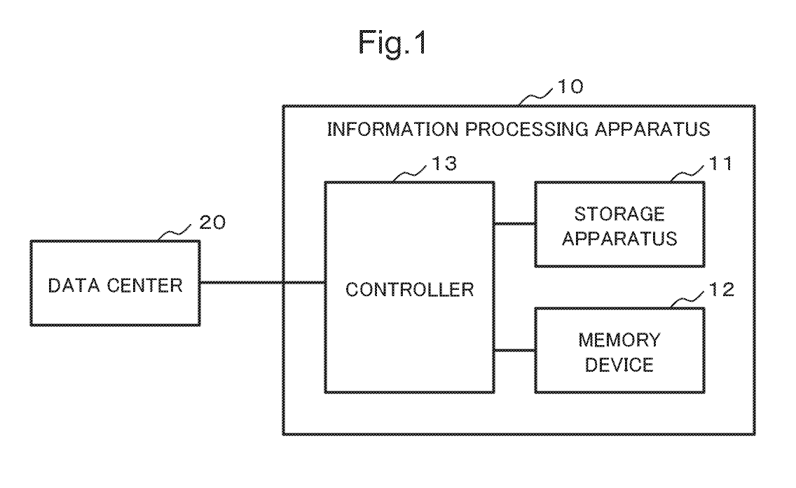

Next, a first example embodiment of the present invention will be described with reference to FIG. 1.

An information processing apparatus 10, namely, an information processing apparatus according to this first example embodiment, includes a storage apparatus 11, namely, a storage apparatus of a mechanical type; a memory device 12, namely, a memory device of a writable type; and a controller 13. The storage apparatus 11 stores, in the relevant storage apparatus 11, a program for allowing the information processing apparatus 10 to operate. Further, the storage apparatus 11 stores first information into the relevant storage apparatus 11 in conjunction with updating of the first information. The first information is information for allowing the information processing apparatus 10 to operate. During normal operation of the storage apparatus 11, the controller 13 transmits second information including at least a portion of the first information to a data center 20. The data center 20 is connected to the information processing apparatus 10 via a communication link. Further, upon detection of a failure of the storage apparatus 11, the controller 13 brings the operation of the storage apparatus 11 to a halt; loads the second information and the program that is preliminarily stored in the data center 20, into the memory device 12 from the data center 20. Further, based on the program and the second information, which have been loaded into the memory device 12, the controller 13 allows the information processing apparatus 10 to operate.

Here, the storage apparatus 11 of a mechanical type may be a hard disk, a magneto optical disk, or the like. Meanwhile, the memory device 12 of a writable type may be a semiconductor-based memory device or the like.

When the information processing apparatus 10 has been subjected to a strong impact due to a disaster or the like, the storage apparatus 11 of a mechanical type is likely to be damaged; while the memory device 12 is unlikely to be damaged because the memory device 12 is a semiconductor-based memory device or the like.

For this reason, even when the storage apparatus 11 has been damaged, the information processing apparatus 10 of the present example embodiment is capable of loading the program for allowing the information processing apparatus 10 to function and the second information that is required at minimum for emergency operation, into the memory device 12 from the data center 20. As a result, the information processing apparatus 10 is capable of carrying out the emergency operation on the basis of the program and the second information, which are stored in the memory device 12.

As described above, even when a failure has occurred in the storage apparatus 11, the information processing apparatus 10 of the present example embodiment is capable of automatically resuming at least a portion of its original operation.

### Second Example embodiment

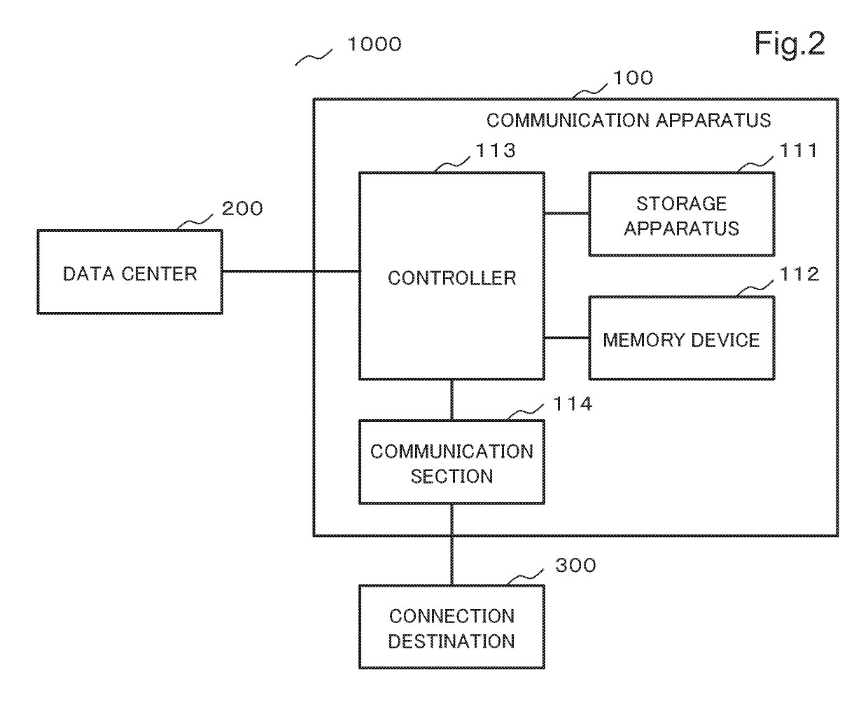

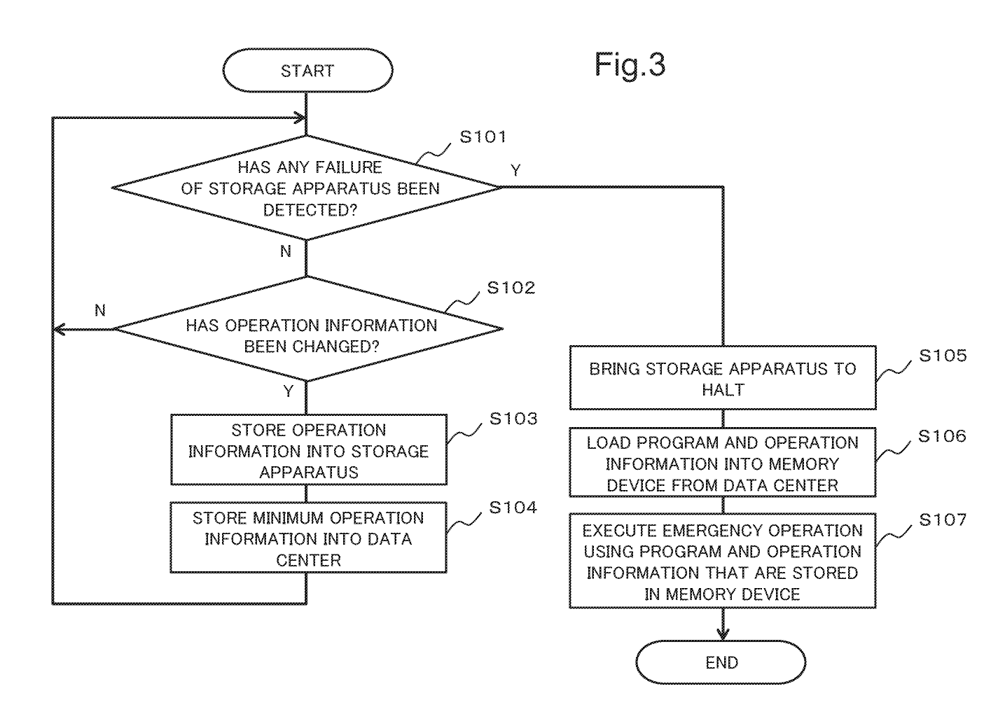

Next, a second example embodiment will be described with reference to FIGS. 2 and 3.

[Description of Configuration]

A configuration example of a communication system 1000, namely, a communication system of the present example embodiment, is illustrated in FIG. 2.

The communication system 1000 is constituted by a communication apparatus 100, a data center 200, and at least one connection destination 300.

Here, the following description will be given on the assumption that the communication apparatus 100 is a wireless base station, and the connection destination 300 is a wireless terminal connected to the wireless base station.

The communication apparatus 100 and the connection destination 300 are interconnected by a first communication link. Further, the communication apparatus 100 and the data center 200 are interconnected by a second communication link.

Although one connection destination 300 is illustrated in FIG. 2, a plurality of connection destinations 300 may exist.

Further, each of the first communication link and the second communication link may be a wireless link or a wired link.

The communication apparatus 100 includes a storage apparatus 111, a memory device 112, a controller 113, and a communication section 114.

The storage apparatus 111 is a storage apparatus of a mechanical type, such as a hard disk drive, a magneto optical disk, or the like.

The memory device 112 is a memory of a writable type. The memory device 112 may be a nonvolatile memory. In most cases, the storage capacity of the memory device 112 is smaller than that of the storage apparatus 111.

The controller 113 includes a central processing unit (CPU), and performs control of hardware and execution of software processing for the communication apparatus 100.

The communication section 114 corresponds to hardware and software for communication, and in the case where the first communication link is a wireless communication link, the communication section 114 corresponds to a circuit and software for use in the execution of wireless communication.

The data center 200 may be a core node, or the like, that is equipped with, for example, another communication apparatus, a server of a cloud system, a monitoring apparatus for use in monitoring of base stations by a network operator, and/or the like. The connection destination 300 is another communication apparatus connected to the communication apparatus 100.

[Description of Operation]

Next, the operation of the present example embodiment will be described with reference to FIG. 3.

The communication apparatus 100 starts its operation and communicates with the connection destination 300 via the first communication link.

In step S101, the controller 113 determines whether or not any failure of the storage apparatus 111 has been detected (S101).

When it is determined in step S101 that the failure has been detected (“Y” in S101), the operation flow proceeds to step S105.

When it is determined in step S101 that the failure has not been detected (“N” in step S101), the operation flow proceeds to step S102.

In step S102, the controller 113 determines whether or not operation information for the communication apparatus 100 has been changed (S102).

Here, the operation information for the communication apparatus 100 may be the number of the connection destinations 300, communication conditions for each of the connection destinations 300, and the like

When it is recognized in step S102 that the operation information has been changed (“Y” in S102), the operation flow proceeds to step S103.

When it is recognized in step S102 that the operation information has not been changed (“N” in S102), the operation flow returns to step S101.

In step S103, the controller 113 stores the operation information (first information) into the storage apparatus 111 (S103).

In step S104, the controller 113 transmits operation information (second information) included in the above operation information (the first information) and required at minimum for emergency operation (described later) of the communication apparatus 100, to the data center 120 via the second communication link. The data center 120 stores the operation information (the second information), which is required for the emergency operation, into the relevant data center 120 (S104).

Here, the emergency operation means minimum operation carried out upon occurrence of a failure of the storage apparatus 111, and corresponds to operation in step S105 and beyond. Further, the emergency operation may be, for example, operation that allows only voice calls to be executed and that brings data communication to a halt, or the like.

Further, as described above, the data center is a node that is equipped with another communication apparatus, a server of a cloud system, a monitoring apparatus for use in monitoring of base stations by a network operator, and/or the like, and that serves as a higher-tier node for wireless base stations. In general, the wireless base station periodically transmits, in its operation, the operation status of the communication apparatus 100 to such a node. This transmission of the operation status of the communication apparatus 100 corresponds to the operation in step S104, that is, the transmission of the operation information (the second information), which is required at minimum for the emergency operation, to the data center 120 from the communication apparatus 100.

Subsequent to step S104, the operation flow returns to step S101.

In step S105, the controller 113 brings the operation of the storage apparatus 111 to a halt (S105).

In step S105, the controller 113 may be further configured to, for example, cause the communication section 114 to operate and notify a maintenance operator for the communication apparatus 100 of the failure of the storage apparatus 111.

In step S106, the controller 113 loads the operation information (the second information), which is required for the emergency operation, and a program that is required for communication through the second communication link and that is preliminarily stored in the data center 120, into the memory device 112 from the data center 120 via the second communication link. Further, the memory device 112 stores in itself the operation information (the second information), required for the emergency operation, and the program, required for the communication (S106).

In step S107, the controller 113 carries out the emergency operation for the communication apparatus 100 on the basis of the operation information (the second information), which is required for the emergency operation and is stored in the memory device 112, and the program, which is required for the communication and is stored in the memory device 112 (S107).

In most of communication apparatuses, the controller 113 records communication logs into the storage apparatus 111 during the normal operation. During the emergency operation in which the memory device 112 operates in substitution for the storage apparatus 111, however, the controller 113 may be configured not to record the communication logs into the memory device 112 because the storage capacity of the memory device 112 is smaller than that of the storage apparatus 111.

Further, during the emergency operation, the controller 13 may be also configured to transmit not the whole but only part of the operation information for the communication apparatus 100, which is transmitted by the communication apparatus 100 to the higher-tier node during the normal operation, so as to reduce the load on the communication apparatus 100 and the load on the memory device 112.

In addition, the emergency operation in step S107 is continued until the completion of the repair or the replacement of the storage apparatus 111 by an operator.

Here, when the communication apparatus 100 has been subjected to a strong impact or the like due to a disaster or the like, the storage apparatus 111 of a mechanical type is likely to be damaged; while the memory device 112 is unlikely to be damaged because the memory device 112 is a semiconductor-based memory device or the like.

Accordingly, in the case where, even though the storage apparatus 111 has been damaged, the memory device 112 is not damaged, the communication apparatus 100 is capable of loading the program for allowing the communication apparatus 100 to function and the second information required at minimum for the emergency operation, into the memory device 112 from the data center 200. As a result, based on the program and the second information 2, which are stored in the memory device 12, the communication apparatus 100 is capable of carrying out the emergency operation.

Although the preferred example embodiments of the present invention have been described heretofore, the present invention is not limited to the above-described example embodiments and the configurations of the example embodiments can be expanded or modified into configurations, such as described below.

Even in the case where the communication apparatus 100, having been described in the second example embodiment, is an information processing apparatus not including the communication section 114 and intended to perform operation other than the communication, this configuration does not deviate from the gist of the present invention.

Further, the present invention is also applicable to a configuration in which an information processing program that achieves the functions of the example embodiments is directly or remotely supplied to a relevant system or a relevant apparatus.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

What is claimed is:

1. An information processing apparatus comprising:
a storage apparatus that is of a mechanical type and is configured to store, in the storage apparatus, a program for allowing the information processing apparatus to operate, and to store first information into the storage apparatus in conjunction with updating of the first information, the first information being information for allowing the information processing apparatus to operate;
a memory device of a writable type; and
a controller configured to, during normal operation of the storage apparatus, transmit second information including at least a portion of the first information to a data center connected to the information processing apparatus via a communication link, the controller being further configured to, upon detection of a failure of the storage apparatus, bring operation of the storage apparatus to a halt, load the second information and the program that is preliminarily stored in the data center, into the memory device from the data center, and allow the information processing apparatus to operate, based on the program and the second information, which have been loaded into the memory device.

2. An information processing system comprising the information processing apparatus according to claim 1, and the data center set forth in claim 1.

3. An information processing method comprising:
storing, in a storage apparatus of a mechanical type, a program for allowing an information processing apparatus to operate, and storing first information into the storage apparatus in conjunction with updating of the first information, the first information being information for allowing the information processing apparatus to operate;
during normal operation of the storage apparatus, transmitting second information including at least a portion of the first information to a data center connected to the information processing apparatus via a communication link; and
upon detection of a failure of the storage apparatus, bringing operation of the storage apparatus to a halt, loading the second information and the program that is preliminarily stored in the data center, into the memory device from the data center, and allowing the information processing apparatus to operate, based on the program and the second information, which have been loaded into the memory device.

4. A communication apparatus comprising:
a communication section configured to communicate through a first communication link;
a storage apparatus that is of a mechanical type and is configured to store, in the storage apparatus, a program for allowing the communication apparatus to operate, and to store first information into the storage apparatus in conjunction with updating of the first information, the first information being information for allowing the communication apparatus to operate;
a memory device of a writable type; and
a controller configured to, during normal operation of the storage apparatus, transmit second information including at least a portion of the first information to a data center connected to the communication apparatus via a second communication link, the controller being further configured to, upon detection of a failure of the storage apparatus, bring operation of the storage apparatus to a halt, load the second information and the program that is preliminarily stored in the data center, into the memory device from the data center, and allow the communication apparatus to operate, based on the program and the second information, which have been loaded into the memory device.

5. A communication system comprising the communication apparatus according to claim 4, and the data center set forth in claim 4.
